(19) United States
(12) Patent Application Publication
(10) Pub. No.: US 2026/0092949 A1
(43) Pub. Date: Apr. 2, 2026

(54) METHOD AND SYSTEM FOR SENSOR BASED CLASSIFICATION

(71) Applicant: INVENSENSE, INC, San Jose, CA (US)

(72) Inventors: JeKwon Yoon, San Jose, CA (US); Juan Mejia Santamaria, San Jose, CA (US); Vishal Vijayakumar, San Jose, CA (US); Karthik Thulasiraman Vishnuraman, San Jose, CA (US); Qing Wang, Sunnyvale, CA (US)

(21) Appl. No.: 19/094,130

(22) Filed: Mar. 28, 2025

Related U.S. Application Data
(60) Provisional application No. 63/701,436, filed on Sep. 30, 2024.

(51) Int. Cl. G01P 15/14; A47J 31/42; G01P 15/08; G01P 15/105

(52) U.S. Cl. CPC G01P 15/14; G01P 15/105; A47J 31/42; G01P 2015/0865

(57) ABSTRACT

Methods and systems are disclosed for sensor-based classification. A collection of subset models that assign one of a plurality of class labels to input data is stored so that a first subset model of the model collection having at least two of the plurality of class labels is loaded in a sensor processing unit based at least in part on a first context. A first set of data is obtained from a sensor of the sensor processing unit and a class label is output for the first set of data from the first subset model. Then at least one subsequent subset model of the model collection is loaded in the sensor processing unit based at least in part on at least one subsequent context. Correspondingly, at least one subsequent set of data is obtained from the sensor so that a class label from the at least one subsequent subset model is output for the at least one subsequent set of data.

### CROSS-REFERENCE TO RELATED APPLICATIONS

This application claims priority to U.S. Provisional Patent Application No. 63/701,436, filed Sep. 30, 2024, the content of which is incorporated by reference in its entirety.

### FIELD OF THE PRESENT DISCLOSURE

This invention relates to the use of sensor information to classify different states of a device incorporating the sensor.

### BACKGROUND

The development of microelectromechanical systems (MEMS) has enabled the incorporation of a wide variety of sensors into a variety of devices. The devices may be portable, such as cell phones, laptops, tablets, headphones, ear buds, gaming devices and other portable, electronic devices. However, devices that are substantially stationary may also benefit from inclusion of one or more types of sensors, and may include without limitation computing devices, input and output devices, appliances, home automation devices, entertainment devices, medical devices and many others.

One typical implementation of a sensor is in the form of a motion sensor assembly, such as an Inertial Measurement Unit (IMU). Typically, inertial motion sensors include gyroscopes that measure angular velocity and accelerometers that measure specific forces along one or more orthogonal axes. The IMU may also be equipped with at least one dedicated sensor processor that performs initial operations regarding the raw sensor data that is output. For example, it may be desirable to use such a processor to make certain interpretations of the sensor data without invoking other processing resources of the device for the sake of efficiency

One advantage associated with equipping such devices with one or more sensors is that such sensors may be employed to gather information about movement conditions or the environment affecting the device as a whole and make a corresponding inference that may be used to control operation of the device. However, sensors may also be used to determine operational characteristics of the device itself. For example, a given operating state of the device may be associated with one or more sensor signatures that may be used to rapidly determine when that operating state exists. As another non-limiting illustration, the device may be manipulated or employed by the user in a way that provides an intentional input used to control the device, such as by employing gesture recognition techniques.

Accordingly, it would be desirable to enable classification of sensor data by assigning one of a plurality of class labels. Further, it would be desirable to increase the accuracy and efficiency of the process for class label assignment. The techniques of this disclosure as described in the following materials satisfies this and other needs.

### SUMMARY

The disclosure is directed to a method for sensor-based classification. The method may involve storing a collection of subset models that assign one of a plurality of class labels to input data at a first processing resource, loading a first subset model of the model collection having at least two of the plurality of class labels in a sensor processing unit based at least in part on a first context, wherein the sensor processing unit is discrete from the first processing resource, obtaining a first set of data from a sensor of the sensor processing unit, outputting a class label for the first set of data from the first subset model, loading at least one subsequent subset model of the model collection from the first processing resource having at least two of the plurality of class labels in the sensor processing unit based at least in part on at least one subsequent context, obtaining at least one subsequent set of data from the sensor and outputting a class label from the at least one subsequent subset model for the at least one subsequent set of data.

This disclosure also includes a device. The device may have a sensor processing unit having at least one sensor and at least one processor, such that the at least one processor is configured to load a first subset model of a collection of subset models that assign one of a plurality of class labels to input data, wherein the first subset model has at least two of the plurality of class labels based at least in part on a first context and wherein the model collection is stored at a first processing resource such that the sensor processing unit is discrete from the first processing resource, obtain a first set of data from the at least one sensor, output a class label for the first set of data from the first subset model, load at least one subsequent subset model of the stored model collection, wherein the at least one subsequent subset model has at least two of the plurality of class labels based at least in part on at least one subsequent context, obtaining at least one subsequent set of data from the at least one sensor of the sensor processing unit and output a class label from the at least one subsequent subset model for the at least one subsequent set of data.

Still further, this disclosure includes a sensor processing unit having at least one sensor and at least one processor. The at least one processor may be configured to load a first subset model of a collection of subset models that assign one of a plurality of class labels to input data, wherein the first subset model has at least two of the plurality of class labels based at least in part on a first context and wherein the model collection is stored at a first processing resource such that the sensor processing unit is discrete from the first processing resource, obtain a first set of data from the at least one sensor, output a class label for the first set of data from the first subset model, load at least one subsequent subset model of the stored model collection, wherein the at least one subsequent subset model has at least two of the plurality of class labels based at least in part on at least one subsequent context, obtain at least one subsequent set of data from the at least one sensor of the sensor processing unit and output a class label from the at least one subsequent subset model for the at least one subsequent set of data.

Correspondingly, the techniques of this disclosure as described in the following materials allow dynamic switching between different classification models during runtime based on the context or operating state of the device. This allows the system to reduce computational overhead, improve classification accuracy by using more targeted models, and enable efficient use of memory-constrained sensor processing units.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic diagram of device having a sensor configuration that allows for context dependent switching of classification modules according to an embodiment.

FIG. 2 is a flowchart showing a routine for sensor based classification according to an embodiment.

FIGS. 3a, 3b, 3c and 3d are schematic representations of accelerometer data corresponding to different stages of device operation according to an embodiment.

FIG. 4 schematically represents the relationship of a collection of subset models that assign one of a plurality of class labels to input data for classification and corresponding subset models according to an embodiment.

FIG. 5 is a flowchart showing operation of a device using a universal classification model according to conventional usage.

FIG. 6 is a flowchart showing operation of a device using context-dependent selection of subset classification model according to an embodiment.

### DETAILED DESCRIPTION

At the outset, it is to be understood that this disclosure is not limited to particularly exemplified materials, architectures, routines, methods or structures as such may vary. Thus, although a number of such options, similar or equivalent to those described herein, can be used in the practice or embodiments of this disclosure, the preferred materials and methods are described herein.

It is also to be understood that the terminology used herein is for the purpose of describing particular embodiments of this disclosure only and is not intended to be limiting.

The detailed description set forth below in connection with the appended drawings is intended as a description of exemplary embodiments of the present disclosure and is not intended to represent the only exemplary embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the specification. It will be apparent to those skilled in the art that the exemplary embodiments of the specification may be practiced without these specific details. In some instances, well known structures and devices are shown in block diagram form in order to avoid obscuring the novelty of the exemplary embodiments presented herein.

For purposes of convenience and clarity only, directional terms, such as top, bottom, left, right, up, down, over, above, below, beneath, rear, back, and front, may be used with respect to the accompanying drawings or chip embodiments. These and similar directional terms should not be construed to limit the scope of the disclosure in any manner.

In this specification and in the claims, it will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the exemplary wireless communications devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor. For example, a carrier wave may be employed to carry computer-readable electronic data such as those used in transmitting and receiving electronic mail or in accessing a network such as the Internet or a local area network (LAN). Of course, many modifications may be made to this configuration without departing from the scope or spirit of the claimed subject matter.

The various illustrative logical blocks, modules, circuits and instructions described in connection with the embodiments disclosed herein may be executed by one or more processors, such as one or more sensor processing units (SPUs), digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structure or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of a Motion Processor Unit (MPU) or Sensor Processing Unit (SPU) and a microprocessor, a plurality of microprocessors, one or more microprocessors in conjunction with an MPU/SPU core, or any other such configuration.

Unless defined otherwise, all technical and scientific terms used herein have the same meaning as commonly understood by one having ordinary skill in the art to which the disclosure pertains.

Finally, as used in this specification and the appended claims, the singular forms “a, “an” and “the” include plural referents unless the content clearly dictates otherwise.

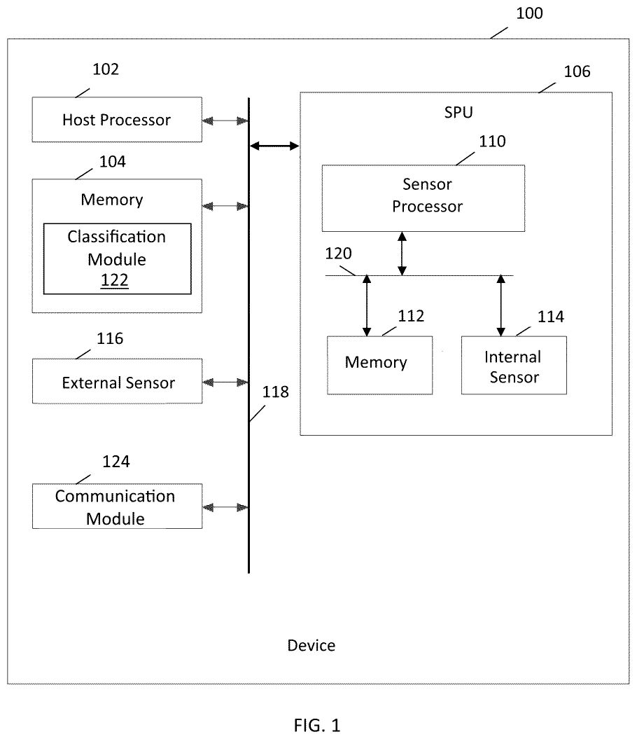

As noted above, the techniques of this disclosure relate to performing a context dependent switch of classification models for using information from motion or other sensors to assign one of a plurality of class labels to input data. Details regarding one embodiment of device 100 including features of this disclosure are depicted as high-level schematic blocks in FIG. 1. As shown, device 100 includes a host processor 102, which may be one or more microprocessors, central processing units (CPUs), or other processors to run software programs, which may be stored in memory 104, associated with the functions of device 100. Multiple layers of software can be provided in memory 104, which may be any combination of computer readable medium such as electronic memory or other storage medium such as hard disk, optical disk, etc., for use with the host processor 102. For example, an operating system layer can be provided for device 100 to control and manage system resources in real time, enable functions of application software and other layers, and interface application programs with other software and functions of device 100. Similarly, different software application programs such as menu navigation software, games, camera function control, navigation software, communications software, such as telephony or wireless local area network (WLAN) software, or any of a wide variety of other software and functional interfaces can be provided. In some embodiments, multiple different applications can be provided on a single device 100, and in some of those embodiments, multiple applications can run simultaneously.

Device 100 includes at least one sensor assembly, implemented in the form of integrated sensor processing units (SPU) 106, which may also be termed an inertial measurement units (IMU). Exemplary details are shown for SPU 106, including sensor processor 110, memory 112 and internal sensor 114. Memory 112 may store algorithms, routines or other instructions for processing data output by internal sensor 114 and/or other sensors as described below using logic or controllers of sensor processor 110, as well as storing raw data and/or motion data output by internal sensor 114 or other sensors. Memory 112 may also be used for any of the functions associated with memory 104. Internal sensor 114 may be one or more sensors for measuring motion of device 100 in space, such as an accelerometer, a gyroscope, a magnetometer, a pressure sensor, a time of flight sensor or other ranging sensor, an environmental sensor or others. In one embodiment, internal sensor 114 may include rotational motion sensors and linear motion sensors. For example, the rotational motion sensors may be gyroscopes to measure angular velocity along three orthogonal axes and the linear motion sensors may be accelerometers to measure linear acceleration along three orthogonal axes. A sensor fusion operation performed by sensor processor 108, or other processing resources of device 100, combines data from internal sensor 114 to provide a six-axis determination of motion or six degrees of freedom (6DOF). In addition to gyroscopes and accelerometers, internal sensor 114 may also have other sensor(s) configured to measure one or more aspects about the environment surrounding device 100, for example, a pressure sensor and/or a magnetometer may be used to refine motion determinations made using internal sensor 114. As desired, internal sensor 114 may be implemented using Micro Electro Mechanical System (MEMS) to be integrated with SPU 106 in a single package. Exemplary details regarding suitable configurations of host processor 102 and SPU 106 may be found in, commonly owned U.S. Pat. No. 8,250,921, issued Aug. 28, 2012, and U.S. Pat. No. 8,952,832, issued Feb. 10, 2015, which are hereby incorporated by reference in their entirety. Suitable implementations for SPU 106 in device 100 are available from TDK InvenSense, Inc. of San Jose, Calif.

Alternatively, or in addition, device 100 may implement one or more sensors in the form of external sensor 116. External sensor 116 may represent one or more sensors as described above, such as an accelerometer and/or a gyroscope, or any other type of sensor. As used herein, “external” means a sensor that is not integrated with SPU 206 but is still associated with one of the device portions. Although described in the context of one or more sensors being MEMS based, the techniques of this disclosure may be applied to any sensor design or implementation. Depending on the embodiment, any combination sensors of internal sensor 114 and external sensor 116 may be used to gather sensor information to be used in the context-dependent selection of subset classification models. For example, in some implementations, accelerometer data, gyroscope data, or accelerometer and gyroscope data corresponding to movement device 100 may be used.

In the embodiment shown, host processor 102, memory 104, SPU 106 and other components of device 100 may be coupled through bus 118, while SPU 106 implements an internal bus 120 for coupling at least sensor processor 108, memory 110, internal sensor 114, either of which may be any suitable bus or interface, such as a peripheral component interconnect express (PCIe) bus, a universal serial bus (USB), a universal asynchronous receiver/transmitter (UART) serial bus, a suitable advanced microcontroller bus architecture (AMBA) interface, an Inter-Integrated Circuit (I2C) bus, a serial digital input output (SDIO) bus, a serial peripheral interface (SPI) or other equivalent. Depending on the architecture, different bus configurations may be employed as desired. For example, additional buses may be used to couple the various components of device 100, such as by using a dedicated bus between host processor 102 and memory 104.

Code, algorithms, routines or other instructions for processing sensor data may be employed by classification module 122, schematically represented in this figure as being stored in memory 104 for execution by host processor 102, to perform any of the operations associated with the techniques of this disclosure. However, it should be appreciated that any or all of the operations may be distributed as desired across all available resources of the device. As will be discussed in further detail below, classification module 122 may be configured to assign one of a plurality of class labels to input data received from internal sensor 114 and/or other sources. Notably, classification module 122 may preferentially load different subsets of a collection of subset models that assign one of a plurality of class labels to input data obtained from internal sensor 114 and/or other sources.

In some embodiments, device 100 may include communications module 124 for any suitable purpose, including for receiving a classification model collection and/or subsets of the model collection. Communications module 124 may employ a Wireless Local Area Network (WLAN) conforming to Institute for Electrical and Electronic Engineers (IEEE) 802.11 protocols, featuring multiple transmit and receive chains to provide increased bandwidth and achieve greater throughput. For example, the 802.11ad (WiGIG™) standard includes the capability for devices to communicate in the 60 GHz frequency band over four, 2.16 GHz-wide channels, delivering data rates of up to 7 Gbps. Other standards may also involve the use of multiple channels operating in other frequency bands, such as the 5 GHz band, or other systems including cellular-based and WLAN technologies such as Universal Terrestrial Radio Access (UTRA), Code Division Multiple Access (CDMA) networks, Global System for Mobile Communications (GSM), IEEE 802.16 (WiMAX), Long Term Evolution (LTE), other transmission control protocol, internet protocol (TCP/IP) packet-based communications, or the like may be used. In some embodiments, multiple communication systems may be employed to leverage different capabilities. Typically, communications involving higher bandwidths may be associated with greater power consumption, such that other channels may utilize a lower power communication protocol such as BLUETOOTH®, ZigBee®, ANT or the like. Further, a wired connection may also be employed. Generally, communication may be direct or indirect, such as through one or multiple interconnected networks. As will be appreciated, a variety of systems, components, and network configurations, topologies and infrastructures, such as client/server, peer-to-peer, or hybrid architectures, may be employed to support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Any combination of sensor components of device 100 may be formed on different chips or may be integrated and reside on the same chip, creating a unitary package. A chip may be defined to include at least one substrate typically formed from a semiconductor material. A single chip or package may be formed from multiple substrates, where the substrates are mechanically bonded to preserve the functionality. A multiple chip includes at least two substrates, wherein the two substrates are electrically connected, but do not require mechanical bonding. A package provides electrical connection between the bond pads on the chip to a metal lead that can be soldered to a PCB. A package typically comprises a substrate and a cover. Integrated Circuit (IC) substrate may refer to a silicon substrate with electrical circuits, typically CMOS circuits. One or more sensors may be incorporated into the package if desired using any suitable technique. In some embodiments, a sensor may be MEMS-based, such that a MEMS cap provides mechanical support for the MEMS structure. The MEMS structural layer is attached to the MEMS cap. The MEMS cap is also referred to as handle substrate or handle wafer. In some embodiments, the first substrate may be vertically stacked, attached and electrically connected to the second substrate in a single semiconductor chip, while in other embodiments, the first substrate may be disposed laterally and electrically connected to the second substrate in a single semiconductor package. In one embodiment, the first substrate is attached to the second substrate through wafer bonding, as described in commonly owned U.S. Pat. No. 7,104,129, which is incorporated herein by reference in its entirety, to simultaneously provide electrical connections and hermetically seal the MEMS devices. This fabrication technique advantageously enables technology that allows for the design and manufacture of high performance, multi-axis, inertial sensors in a very small and economical package. Integration at the wafer-level minimizes parasitic capacitances, allowing for improved signal-to-noise relative to a discrete solution. Such integration at the wafer-level also enables the incorporation of a rich feature set which minimizes the need for external amplification.

In the described embodiments, raw data refers to measurement outputs from the sensors which are not yet processed. Motion data may refer to processed and/or raw data. Processing may include applying a sensor fusion algorithm or applying any other algorithm. In the case of a sensor fusion algorithm, data from a plurality of sensors may be combined to provide, for example, an orientation of the device. In the described embodiments, a SPU may include processors, memory, control logic and sensors among structures.

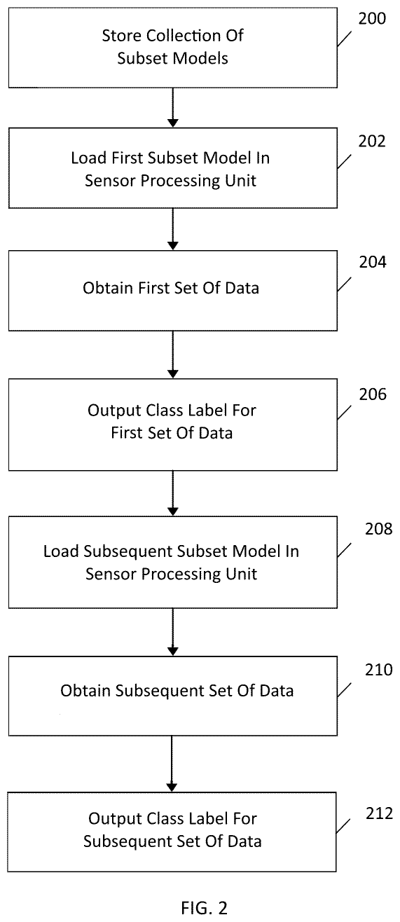

To help illustrate aspects of the techniques of this disclosure, FIG. 2 schematically depicts one suitable routine for performing sensor-based classification inferencing. Particularly, the routine may begin at 200 by storing a collection of subset models that assign one of a plurality of class labels to input data. The model collection is stored at a first processing resource, which may be local to device 100 such as in memory 104 for access by host processor 102. Alternatively or in addition, the model collection may be stored at a remote processing resource so that it or any subsets of the model collection may be obtained using communication module 124. Next, a first subset model of the model collection having at least two of the plurality of class labels is loaded in a sensor processing unit 106 in 202. Classification module 122 may select the first subset model based at least in part on a first context of device 100 as discussed below. Although sensor processing unit 106 is coupled to the first processing resource via bus 118 and, in embodiments where the model collection is stored remotely, via communication module 124, the sensor processing unit represents a discrete processing resource. In 204, a first set of data is obtained from a sensor of the sensor processing unit 106. In embodiments where sensor processing unit 106 functions as an IMU, the sensor may be at least one of a motion sensor such as an accelerometer and a gyroscope as per the discussion above. In other embodiments, other types of sensors may be employed as desired. Correspondingly, a class label for the first set of data is output in 206 from the first subset model. Next, in 208, at least one subsequent subset model of the model collection is loaded from the first processing resource in sensor processing unit 106. Again, the subsequent subset model has at least two of the plurality of class labels. Classification module 122 may select the subsequent subset model based at least in part on at least one subsequent context of device 100. Accordingly, at least one subsequent set of data from the sensor may then be obtained in 210 so that a class label from the at least one subsequent subset model may be output for the at least one subsequent set of data in 212.

The collection of classification subset models is configured to assign one of a plurality of class labels to input data received from at least one of the sensors of device 100, such as internal sensor 114 or external sensor 116. The collection of classification subset models may be implemented using any suitable machine learning (ML) technique that involves employing a set of training data to correlate each of the plurality of class labels to characteristic patterns in the training data. Often, the model is then verified using test data to determine whether the classification is sufficiently accurate or whether addition training data is required so that the model can learn the appropriate classifications for the data. The model built with such techniques is then able to assign a class label to newly obtained data during use. It should be appreciated that any type of classification model may be used as desired, such as logistic regression, decision trees, random forests, support vector machines, naïve Bayes classifiers and others.

In one embodiment, a collection of machine learning models (the model collection) is stored in a format optimized for efficient loading, with individual subset models selectively deployed to sensor processing unit 106 to dynamically load and utilize only the specific subset model required to perform the desired classification at a given time and such an approach reduces load times and conserves memory and bandwidth. As one non-limiting illustration, memory 112 of sensor processing unit 1206 may load a subset model in approximately 60 ms. To conserve resources, loading a subset model may overwrite a previously loaded subset model. Loading of the subset model may occur on-the-fly without power cycling sensor processing unit 106 to facilitate uninterrupted operation. During the switch between subset models, sensor processing unit 106 may suspend detections to allow the new subset model to be loaded. Further efficiencies are represented by the techniques of this disclosure, for example sensor processing unit 106 may execute the currently loaded subset model without involvement of host processor 104 to conserve energy and send an interrupt only when warranted by the class label that is assigned for a given set of data.

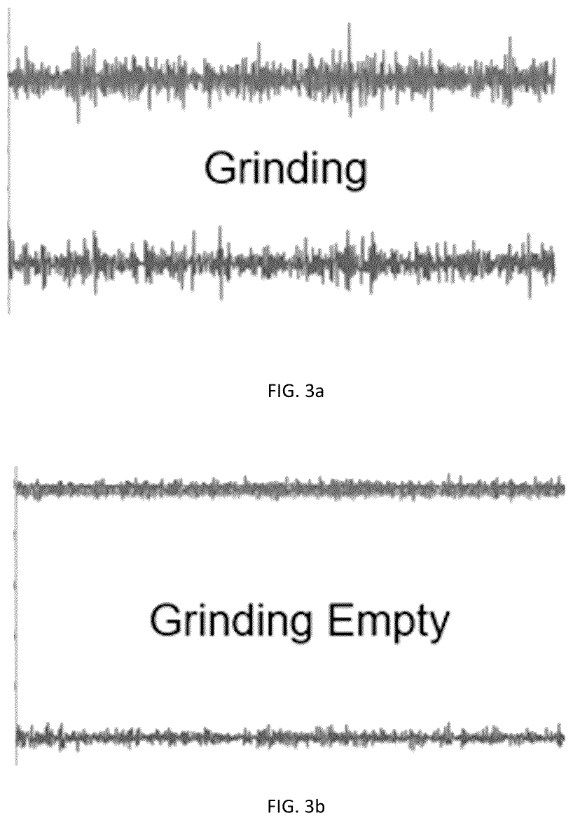

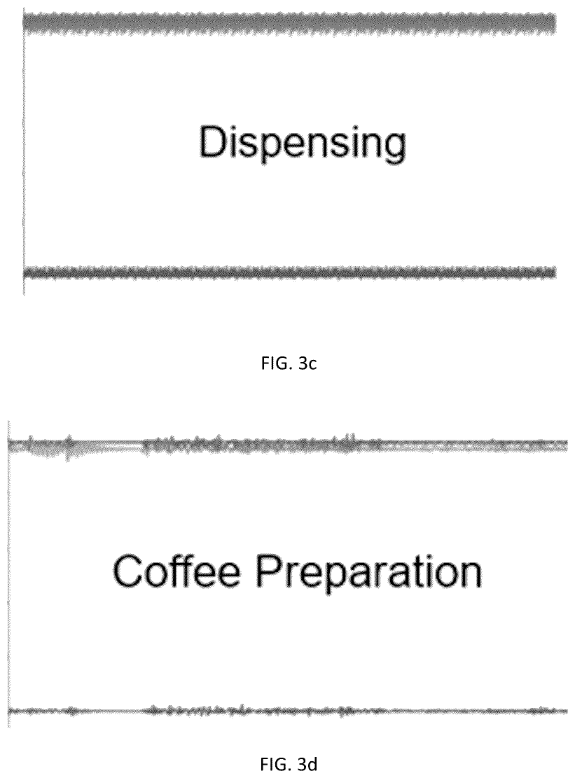

To help illustrate aspects of the techniques of this disclosure, one example of device 100 is a coffee machine that may have a variety of operating conditions, including standby, button press, grinding, empty grinding, dispensing, coffee preparation, and potentially others. Characteristic patterns of accelerometer data are depicted in FIG. 3 for examples of these conditions, specifically FIG. 3a represents data measurements during grinding, FIG. 3b represents data measurements during grinding when empty, FIG. 3c represents data measurements during dispensing and FIG. 3d represents data measurements during coffee preparation. In each graph, the two top traces correspond to accelerometer measurements on the y- and z-axes while the bottom trace corresponds to accelerometer measurements on the x-axis. Data sets such as these may be used to train the classification model collection, from which one or more subset models can be derived and used depending on the context of device 100.

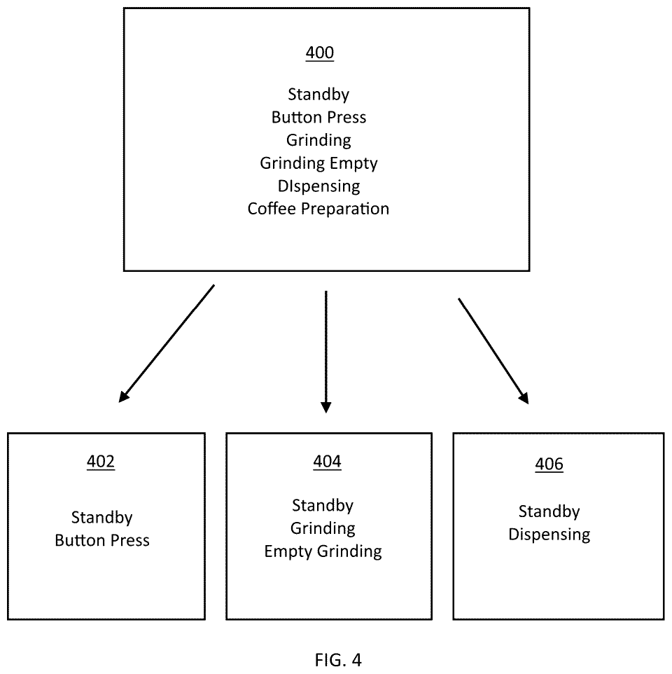

The relationship between the model collection and the subset models is schematically illustrated in FIG. 4, where model collection 400 includes all the relevant class labels and each subset model includes at least two of the class labels. In this illustration, subset model 402 classifies between labels standby and button press, subset model 404 classifies among labels standby, grinding and empty grinding and subset model 406 classifies between labels standby and dispensing. Accordingly, classification module 122 then selects among the subset models depending on the context of device 100, which in this embodiment can represent different stages of coffee preparation. For example, initially model 402 can be employed to distinguish between a standby mode and when the user is interacting with device 100 by pressing a button. There is no need for other class labels at this stage of operation. Similarly, once a button press label has been assigned, classification module 122 can overwrite subset model 402 with model 404 can then be loaded in sensor processing unit 106 to detect when grinding is occurring or when the grinder is empty. Likewise, subset model 406 can be used to distinguish between dispensing and standby modes. Additional subset models may be used with other class labels as warranted for different stages of coffee machine operation.

Segmenting the model collection into different subset models facilitates the collection of data, the training using the collected data and the validation of the built model. For example, it has been observed that when the number of class labels used by a given model increases, there is a corresponding increase in the time required to iterate that data collection, training and validation stages. Further, classification accuracy is inherently improved when fewer class labels are involved. At the least, employing a subset model that does not assign labels for irrelevant conditions prevents false positives from interfering with operation. In the context of the example above, model 402 does not employ a grinding class label so the possibility of erroneously detecting that condition when device 100 is in standby mode is obviated. Additionally, the accuracy of classification may also be improved by tailoring a given subset model to the type of classification being performed. For example, different types of classifications may benefit from employing different windows or different numbers of features for analyzing the data. By reducing the number of class labels, a more suitable window or different features may be employed as opposed to requiring a common window or all features for all possible classes. Still further, changes to one subset model do not need to be propagated through all subset models to reduce the need for retraining or rebuilding the model. Likewise, it may be relatively less complex to acquire training data, extract features, build models and/or validate models when fewer classification labels are represented in the desired output.

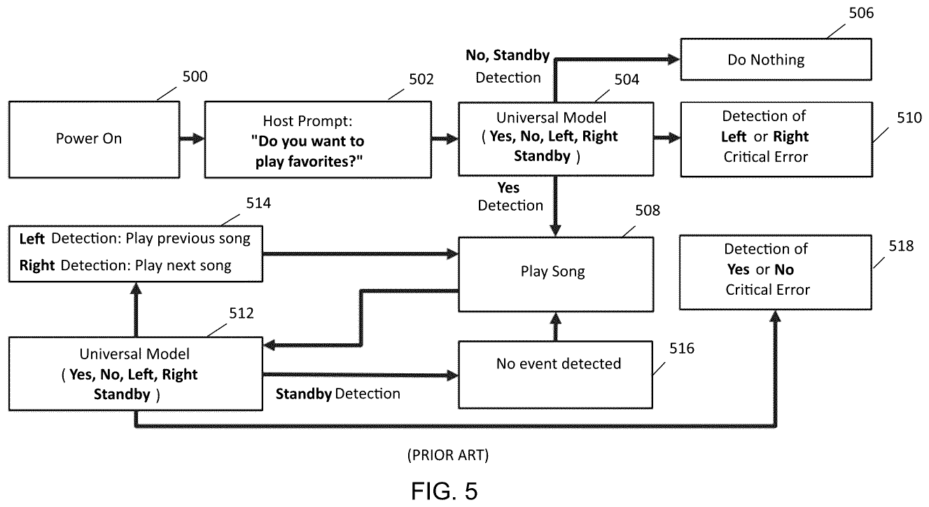

As another illustration of the techniques of this disclosure, the following discussion relates to another example in which sensor information may be used to help control operation of a device. Specifically, FIG. 5 shows a flowchart of operation for Bluetooth ear buds that employs a conventional implementation of gesture recognition classification according to the prior art. Sensor data is used to distinguish between the user nodding, which is interpreted as “Yes,” the user head shaking, which is interpreted as “No,” the user looking left, which is interpreted as “Left,” the user looking right, which is interpreted as “Right,” and no head motion, which is interpreted as “Standby.” As indicated, the routine may begin at 500 when the ear buds are powered on and paired with an audio source. At 502, the host may prompt the user “Do you want to play favorites?” At 504, a universal classification model is used to recognize any of the Yes, No, Left, Right and Standby gestures to help control operation of the ear buds. As indicated, correct detection of a No or Standby gesture causes the routine to branch to 506, where the ear buds do nothing and correct detection of a Yes gesture causes the routine to branch to 508 where a song from the favorites playlist is played. However, an incorrect detection of Left or Right results in a critical error for the host in 510, since neither of these gestures is appropriate for the current context. Similarly, during the context of playing a song in 508, the routine branches to 512 where the universal model is used to monitor for another control gesture. Again, correct detection results in proper operation of the ear buds. For example, correct detection of a Left or Right gesture causes the routine to branch to 514, where the ear buds either play the previous song or the next song on the playlist, respectively and the routine returns to 508. Otherwise, a correct detection of a Standby gesture causes the routine to branch to 516, indicating that no event has been detected and the current song continues to play in 508. Once more, the use of the universal model creates that possibility of inaccurate detections that may interfere with operation of the ear buds. As shown, if either Yes or No is incorrectly detected in 512, a critical error for the host occurs at 518 since neither of these commands is appropriate for the current context.

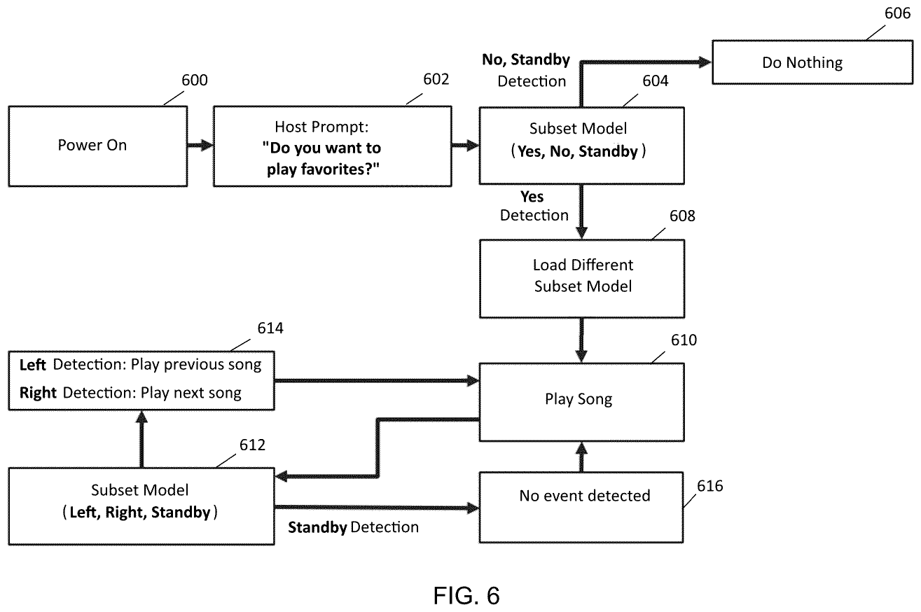

For comparison, FIG. 6 also illustrates a flowchart of operation for Bluetooth ear buds, but here the techniques of this disclosure are employed such that a context-dependent selection is made among subset models of a model collection that includes the same classes as discussed above, namely “Yes,” “No,” “Left,” “Right,” and “Standby.” Operation begins in the same way at 600 when the ear buds are powered on and paired with an audio source. Again, at 602, the host may prompt the user “Do you want to play favorites?” As opposed to the conventional approach given above, in this implementation a subset model is employed in 604 that employs Yes, No and Standby labels. This may be a subset model that was loaded during initialization or otherwise selected by classification module 122. Thus, the only possible detections are Yes, No and Standby, such that correct detection of a No or Standby gesture causes the routine to branch to 606, where the ear buds do nothing and correct detection of a Yes gesture causes the routine to branches through 608 to 610 where a song from the favorites playlist is played. Notably, Left and Right cannot be incorrectly detected, so this routine does not exhibit the possibility for error represented by 510 above. Further, at 608 a new subset model is loaded into sensor processing unit 106 by classification module 122 to accommodate the playing song context of block 610. As shown, the routine branches to 612 where the newly loaded subset model is used to monitor for another control gesture, this time employing the class labels Left, Right and Standby. Here also the techniques of this disclosure reduce the chance of exception because class labels that are not relevant for this context will not be incorrectly assigned. For example, correct detection of a Left or Right gesture causes the routine to branch to 614, where the ear buds either play the previous song or the next song on the playlist, respectively and the routine returns to 608. Otherwise, a correct detection of a Standby gesture causes the routine to branch to 616, indicating that no event has been detected and the current song continues to play in 608.

From the above discussion, it will be appreciated that this disclosure includes a method for sensor-based classification. The method may involve storing a collection of subset models that assign one of a plurality of class labels to input data at a first processing resource, loading a first subset model of the model collection having at least two of the plurality of class labels in a sensor processing unit based at least in part on a first context, wherein the sensor processing unit is discrete from the first processing resource, obtaining a first set of data from a sensor of the sensor processing unit, outputting a class label for the first set of data from the first subset model, loading at least one subsequent subset model of the model collection from the first processing resource having at least two of the plurality of class labels in the sensor processing unit based at least in part on at least one subsequent context, obtaining at least one subsequent set of data from the sensor and outputting a class label from the at least one subsequent subset model for the at least one subsequent set of data.

In one aspect, the model collection may be a machine learning algorithm.

In one aspect, loading the at least one subsequent subset model overwrites a previous subset model.

In one aspect, at least one output class label is used to control operation of a device.

In one aspect, the sensor may be an inertial motion sensor. In some embodiments, the sensor may be an inertial motion unit and a magnetometer.

In one aspect, the first set of data and the at least one subsequent set of data each further may be data from at least one additional sensor. The first set of data and the at least one subsequent set of data each are obtained from an accelerometer and a gyroscope.

This disclosure also includes a device. The device may have a sensor processing unit having at least one sensor and at least one processor, such that the at least one processor is configured to load a first subset model of a a collection of subset models that assign one of a plurality of class labels to input data, wherein the first subset model has at least two of the plurality of class labels based at least in part on a first context and wherein the model collection is stored at a first processing resource such that the sensor processing unit is discrete from the first processing resource, obtain a first set of data from the at least one sensor, output a class label for the first set of data from the first subset model, load at least one subsequent subset model of the stored model collection, wherein the at least one subsequent subset model has at least two of the plurality of class labels based at least in part on at least one subsequent context, obtaining at least one subsequent set of data from the at least one sensor of the sensor processing unit and output a class label from the at least one subsequent subset model for the at least one subsequent set of data.

In one aspect, the model collection may be stored locally on the device.

In one aspect, the model collection is stored remotely and obtained wirelessly.

In one aspect, the device comprises at least one host processor. The at least one host processor may be configured to determine the first context and the at least one subsequent context. The at least one host processor may be configured to determine at least one of the first context and the at least one subsequent context based at least in part on an operational state of the device. The at least one host processor may be configured to select the first subset model and at least one subsequent subset model for loading by the at least one processor of the sensor processing unit.

In one aspect, the first set of data and the at least one subsequent set of data each further may include data from at least one additional sensor that is integrated with the sensor processing unit.

In one aspect, the first set of data and the at least one subsequent set of data each further may include data from at least one additional sensor that is external to the sensor processing unit.

In one aspect, at least one output class label may be used to control operation of the device. At least one of the plurality of class labels may correspond to motions of a user of the device. Alternatively or in addition, at least one of the plurality of class labels may correspond to a status of the device.

Still further, this disclosure includes a sensor processing unit having at least one sensor and at least one processor. The at least one processor may be configured to load a first subset model of a collection of subset models that assign one of a plurality of class labels to input data, wherein the first subset model has at least two of the plurality of class labels based at least in part on a first context and wherein the model collection is stored at a first processing resource such that the sensor processing unit is discrete from the first processing resource, obtain a first set of data from the at least one sensor, output a class label for the first set of data from the first subset model, load at least one subsequent subset model of the stored model collection, wherein the at least one subsequent subset model has at least two of the plurality of class labels based at least in part on at least one subsequent context, obtain at least one subsequent set of data from the at least one sensor of the sensor processing unit and output a class label from the at least one subsequent subset model for the at least one subsequent set of data.

In one aspect, the first set of data and the at least one subsequent set of data each further may include data from at least one additional sensor that is integrated with the sensor processing unit.

In one aspect, the first set of data and the at least one subsequent set of data each further may include data from at least one additional sensor that is external to the sensor processing unit.

Although the present invention has been described in accordance with the embodiments shown, one of ordinary skill in the art will readily recognize that there may be variations to the embodiments and those variations would be within the spirit and scope of the present invention. One skilled in the art may readily devise other systems consistent with the disclosed embodiments which are intended to be within the scope of this disclosure.

What is claimed is:

1. A method for sensor-based classification, comprising:
storing a collection of subset models configured to assign one of a plurality of class labels to input data at a first processing resource;
loading a first subset model of the model collection having at least two of the plurality of class labels in a sensor processing unit based at least in part on a first context, wherein the sensor processing unit is discrete from the first processing resource;
obtaining a first set of data from a sensor of the sensor processing unit;
outputting a class label for the first set of data from the first subset model;
loading at least one subsequent subset model of the model collection from the first processing resource having at least two of the plurality of class labels in the sensor processing unit based at least in part on at least one subsequent context;
obtaining at least one subsequent set of data from the sensor; and
outputting a class label from the at least one subsequent subset model for the at least one subsequent set of data.

2. The method of claim 1, wherein the model collection comprises a machine learning algorithm.

3. The method of claim 1, wherein loading the at least one subsequent subset model overwrites a previous subset model.

4. The method of claim 1, wherein at least one output class label is used to control operation of a device.

5. The method of claim 1, wherein the sensor comprises an inertial motion sensor.

6. The method of claim 1, wherein the sensor comprises an inertial motion unit and a magnetometer.

7. The method of claim 1, wherein the first set of data and the at least one subsequent set of data each further comprises data from at least one additional sensor.

8. The method of claim 7, wherein the first set of data and the at least one subsequent set of data each are obtained from an accelerometer and a gyroscope.

9. A device comprising:
a sensor processing unit having at least one sensor and at least one processor; wherein the at least one processor is configured to:
load a first subset model of a collection of subset models that is configured to assign one of a plurality of class labels to input data, wherein the first subset model has at least two of the plurality of class labels based at least in part on a first context and wherein the model collection is stored at a first processing resource such that the sensor processing unit is discrete from the first processing resource;
obtain a first set of data from the at least one sensor;
output a class label for the first set of data from the first subset model;
load at least one subsequent subset model of the stored model collection, wherein the at least one subsequent subset model has at least two of the plurality of class labels based at least in part on at least one subsequent context;
obtaining at least one subsequent set of data from the at least one sensor of the sensor processing unit; and
output a class label from the at least one subsequent subset model for the at least one subsequent set of data.

10. The device of claim 9, wherein the model collection is stored locally on the device.

11. The device of claim 9, wherein the model collection is stored remotely and obtained wirelessly.

12. The device of claim 9, wherein the device comprises at least one host processor.

13. The device of claim 12, wherein the at least one host processor is configured to determine the first context and the at least one subsequent context.

14. The device of claim 13, wherein the at least one host processor is configured to determine at least one of the first context and the at least one subsequent context based at least in part on an operational state of the device.

15. The device of claim 12, wherein the at least one host processor is configured to select the first subset model and at least one subsequent subset model for loading by the at least one processor of the sensor processing unit.

16. The device of claim 9, wherein the first set of data and the at least one subsequent set of data each further comprises data from at least one additional sensor that is integrated with the sensor processing unit.

17. The device of claim 9, wherein the first set of data and the at least one subsequent set of data each further comprises data from at least one additional sensor that is external to the sensor processing unit.

18. The device of claim 9, wherein at least one output class label is used to control operation of the device.

19. The device of claim 18, wherein at least one of the plurality of class labels corresponds to motions of a user of the device.

20. The device of claim 18, wherein at least one of the plurality of class labels corresponds to a status of the device.

21. A sensor processing unit comprising:
at least one sensor; and
at least one processor; wherein the at least one processor is configured to:
load a first subset model of a collection of subset models that is configured to assign one of a plurality of class labels to input data, wherein the first subset model has at least two of the plurality of class labels based at least in part on a first context and wherein the model collection is stored at a first processing resource such that the sensor processing unit is discrete from the first processing resource;
obtain a first set of data from the at least one sensor;
output a class label for the first set of data from the first subset model;
load at least one subsequent subset model of the stored model collection, wherein the at least one subsequent subset model has at least two of the plurality of class labels based at least in part on at least one subsequent context;
obtain at least one subsequent set of data from the at least one sensor of the sensor processing unit; and
output a class label from the at least one subsequent subset model for the at least one subsequent set of data.

22. The sensor processing unit of claim 21, wherein the first set of data and the at least one subsequent set of data each further comprises data from at least one additional sensor that is integrated with the sensor processing unit.

23. The sensor processing unit of claim 21, wherein the first set of data and the at least one subsequent set of data each further comprises data from at least one additional sensor that is external to the sensor processing unit.
